(19) United States
(12) Patent Application Publication
(10) Pub. No.: US 2008/0174246 A1
(43) Pub. Date: Jul. 24, 2008

(54) Composition for a barrier rib and plasma display panel manufactured with the same

(76) Inventor: Jin-Keun Jung, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/822,349

(22) Filed: Jul. 5, 2007

(30) Foreign Application Priority Data
Jan. 18, 2007 (KR) 10-2007-0005626

(51) Int. Cl. H01J 1/62; C03C 6/02

(52) U.S. Cl. 313/584; 501/27

(57) ABSTRACT

A barrier rib composition includes a ceramic material, a binder, a solvent, and a selenium oxide additive.

### BACKGROUND OF THE INVENTION

1. Field of the Invention

Embodiments of the present invention relate to a barrier rib composition and a plasma display panel (PDP) manufactured with the same. More particularly, embodiments of the present invention relate to a barrier rib composition providing an enhanced decomposition rate of organic components therein.

2. Description of the Related Art

A plasma display panel (PDP) refers to a display device capable of displaying images via gas discharge phenomenon, i.e., excitation of a photoluminescent material with vacuum ultraviolet (VUV) light generated by plasma discharge. Accordingly, the PDP may provide superior display characteristics, such as large and high-resolution display, excellent color reproduction, and wide viewing angles, as compared to conventional display devices. A conventional PDP, e.g., a reflective alternating current driven PDP, may include address electrodes on a rear substrate, display electrodes on a front substrate, barrier ribs between the front and rear substrates to define discharge cells, and a photoluminescent material in the discharge cells.

The conventional barrier ribs of a PDP may be formed of a ceramic material by painting, coating, or a sheet method. In a conventional sheet method, for example, a slurry paste may be applied to a base film by, e.g., roll coating, blade coating, slit coating, wire coating, screen printing and so forth, and subsequently, may be dried to form, e.g., barrier ribs having a height of about 165 to 225 μm. The conventional slurry paste may include a solvent and a binder, in addition to a ceramic material, in order to provide a sufficiently high viscosity to shape the slurry paste into barrier ribs. Once the slurry paste is shaped into the barrier ribs, drying and firing processes may be performed to remove the solvent and the binder from the barrier ribs. A protective cover film may be applied to the dried membrane.

However, the firing process of the barrier ribs may be insufficient to remove the binder from the barrier ribs. More specifically, heat generated during the firing process may be insufficient to penetrate through the barrier ribs, e.g., due to barrier rib thickness, in order to weaken and remove the binder. For example, a firing process at a temperature of at least about 400° C. may be performed for a substantially long duration in order to only partially break down the binder into residual carbon, e.g., C, CO, (CH)²⁹, (CH)⁴⁵, and so forth, prior to removal thereof. In this respect, it should be noted that “CH” refers to a hydrocarbon component, and the numerical superscript refers to a molecular weight thereof.

Accordingly, portions of non-decomposed binder may remain in the barrier ribs, thereby generating a significant source of impurities therein. Further, remaining residual carbon in the barrier ribs may diffuse into the photoluminescent material coated on the barrier ribs and cause reduced discharge properties, e.g., deteriorated brightness of the light emitted from the photoluminescent material, decreased lifespan of the photoluminescent materials, and overall low luminance efficiency of the PDP. Therefore, there exists a need for a PDP having barrier ribs with a reduced amount of impurities.

### SUMMARY OF THE INVENTION

Embodiments of the present invention are therefore directed to a composition for barrier ribs and a plasma display panel (PDP) manufactured therewith, which substantially overcome one or more of the disadvantages of the related art.

It is therefore a feature of embodiments of the present invention to provide a barrier rib composition capable of reducing damage to barrier ribs and discharge cells due to impurities.

It is another feature of embodiments of the present invention to provide a PDP with barrier ribs capable of enhancing luminance efficiency and life span of the PDP.

At least one of the above and other features and advantages of the present invention may be realized by providing a barrier rib composition, including a ceramic material, a binder, a solvent, and at least one oxide additive in an amount of about 1% to about 10% by weight of the barrier rib composition.

The oxide additive may include a selenium oxide. The oxide additive may further include at least one metal oxide. The metal oxide may be one or more of vanadium oxide, molybdenum oxide, and cerium oxide. The selenium oxide and the metal oxide may be at a weight ratio of about 1:1.

The oxide additive may include at least two of a selenium oxide, a vanadium oxide, a molybdenum oxide, and a cerium oxide. The oxide additive may include at least three of a selenium oxide, a vanadium oxide, a molybdenum oxide, and a cerium oxide.

The ceramic material of the barrier rib composition may include glass powder. The glass powder may include one or more of a lead oxide, a silicon oxide, an aluminum oxide, a magnesium oxide, and a titanium oxide. The binder of the barrier rib composition may include one or more of an acryl-based compound, an epoxy-based compound, and a cellulose-based compound. The binder may be a cellulose-based compound, such as ethyl-cellulose-based compound or nitro-cellulose-based compound. The solvent of the barrier composition may include one or more of ethanol, trimethylpentanediol monoisobutylate, butyl carbitol, butyl cellosolve, butyl carbitol acetate, terpineol, toluene, and texanol.

At least one of the above and other features and advantages of the present invention may be also realized by providing a PDP, including a first substrate facing a second substrate, a plurality of address electrodes on the first substrate, a plurality of display electrodes on the second substrate, a plurality of barrier ribs between the first substrate and the second substrate to define a plurality of discharge cells, the plurality of barrier ribs including at least one of a selenium oxide and a metal oxide, and a photoluminescent material in the discharge cells.

The barrier ribs may include at least one of a selenium oxide and a metal oxide in an amount of about 1% to about 10% by weight of the barrier ribs. The barrier ribs may include a selenium oxide and a metal oxide. The barrier ribs may include a selenium oxide and a metal oxide at a weight ratio of about 1:1. The metal oxide may include a vanadium oxide, a molybdenum oxide, or a cerium oxide. The barrier ribs may include at least two of a selenium oxide, a vanadium oxide, a molybdenum oxide, and a cerium oxide.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partial exploded perspective view of a plasma display panel according to an exemplary embodiment of the present invention; and

FIG. 2 illustrates a graph of a thermogravimetric analysis of barrier ribs compositions according to an exemplary embodiment of the present invention as compared to the conventional art.

### DETAILED DESCRIPTION OF THE INVENTION

Korean Patent Application No. 10-2007-0005626 filed on Jan. 18, 2007, in the Korean Intellectual Property Office, and entitled: “Composition for Barrier Rib, and Plasma Display Panel Manufactured with the Same,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present.

An exemplary embodiment of a composition for barrier ribs according to the present invention will now be described in more detail. The composition for barrier ribs according to an embodiment of the present invention may include a ceramic material, a binder, a solvent, and at least one oxide additive. Terminology such as “barrier rib composition,” “barrier ribs composition,” “composition for barrier ribs,” and like terminology may be used interchangeably throughout the specification.

The ceramic material of the barrier rib composition may include any material suitable for forming barrier ribs as determined by one of ordinary skill in the art. For example, the ceramic material may include glass powder, such as lead oxide (PbO), silicon oxide (SiOₓ), aluminum oxide (Al₂O₃), magnesium oxide (MgO), titanium oxide (TiO₂), and combinations thereof. The ceramic material may include inorganic glass powder without PbO.

The binder of the barrier rib composition may include any polymer resin as determined by one of ordinary skill in the art. For example, the polymer resin may include one or more of acryl-based resin, epoxy-based resin, cellulose-based resin, e.g., ethyl cellulose (EC) or nitro cellulose (NC), and so forth.

The solvent of the barrier rib composition may include any organic solvent as determined by one of ordinary skill in the art. For example, the organic solvent may include one or more of ethanol, trimethylpentanediol monoisobutylate (TPM), butyl carbitol (BC), butyl cellosolve (BC), butyl carbitol acetate (BCA), terpineol (TP), toluene, texanol, and so forth.

The oxide additive of the barrier rib composition may include one or more of a selenium oxide (SeO₂) and a metal oxide, e.g., vanadium oxide (V₂O₅), molybdenum oxide (MoO₃), cerium oxide (CeO₂), and so forth. For example, the barrier rib composition may include a single oxide additive, i.e., a selenium oxide. In another example, the barrier rib composition may include two oxide additives, i.e., the selenium oxide (SeO₂) and at least one metal oxide. In yet another example, the barrier rib composition may include any one or more of the selenium oxide (SeO₂), vanadium oxide (V₂O₅), molybdenum oxide (MoO₃), cerium oxide (CeO₂), and so forth, e.g., at least two or three oxide additives.

A total amount of the oxide additive employed in the barrier rib composition may be in a range of from about 1% to about 10% by weight based on a total weight of the barrier ribs composition. When more than one oxide additive is used in the barrier rib composition, the oxide additives may be employed at equal proportions. For example, the selenium oxide and the molybdenum oxide may be mixed at a weight ratio of about 1:1 to form the oxide additive. When the amount of additive is less than about 1% by weight of the total barrier ribs composition, the additive amount may be insufficient to provide effective removal of residual carbon. When the amount of additive is more than about 10% by weight of the total barrier ribs composition, the viscosity of the barrier rib composition may be insufficient to provide effective support to the substrates of the PDP.

Without intending to be bound by theory, it is believed that including at least one oxide additive in the barrier rib composition according to an embodiment of the present invention may facilitate a faster decomposition rate of the binder at lower temperatures. More specifically, the oxide additive may facilitate heat transfer through the barrier ribs during the firing process, and may weaken binding properties of the binder, thereby increasing the binder decomposition rate at a predetermined temperature. In further detail, the oxide additive may chemically bond only with the binder, i.e., no chemical interaction between the oxide additive and the ceramic material, so that only a small amount of the oxide additive may be sufficient to weaken chemical bonding of the binder, thereby accelerating binder decomposition and removal thereof. Accordingly, barrier ribs formed of the barrier rib composition according to an embodiment of the present invention, i.e., with an oxide additive, may include a significantly lower amount of impurities.

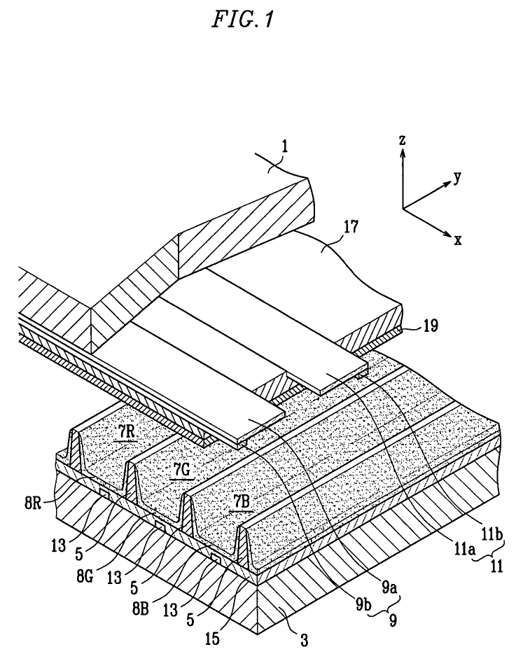

According to another exemplary embodiment of the present invention, a PDP may be formed to include barrier ribs formed of the barrier ribs composition described above. More specifically, as illustrated in FIG. 1, the PDP may include a first substrate 3, a second substrate 1 facing the first substrate, and barrier ribs 5 between the first and second substrates 3 and 1. A plurality of address electrodes 13 in a first direction, i.e., along the y-axis, may be disposed on the first substrate 3, and may be coated with a first dielectric layer 15. A plurality of display electrodes in a second direction, i.e., along the x-axis, may be disposed on the second substrate 1, and may be coated with a second dielectric layer 17 and a protective layer 19.

The barrier ribs 5 of the PDP may be formed of the composition described previously, and therefore, detailed description of the barrier rib composition will not be repeated herein. The barrier ribs 5 of the PDP may be formed in any suitable shape as determined by one of ordinary skill in the art, so that a discharge space between the first and second substrates 3 and 1 may be partitioned into discharge cells 7R, 7G, and 7B. For example, the barrier ribs 5 may be arranged to form a striped-pattern, a waffle-pattern, a matrix-pattern, a delta-pattern, and so forth. A cross-sectional area of each barrier rib 5 in the horizontal direction, i.e., the xy-plane, may be, e.g., quadrangular, triangular, pentagonal, circular, oval, and so forth. Each discharge cell 7R, 7G, and 7B may be positioned at an intersection point between an address electrode 13 of the first substrate 3 and a display electrode of the second substrate 1, and may emit a specific color of light, i.e., red, green, or blue. A respective photoluminescent layer 8R, 8G, or 8B may be disposed in each discharge cells 7R, 7G, and 7B.

The display electrodes of the PDP may include pairs of first display electrodes 9 and second display electrodes 11. Each pair of display electrodes, i.e., a first display electrode 9 and a second display electrode 11, may include transparent electrodes 9a and 11a, respectively, and bus electrodes 9b and 11b, respectively. The display electrodes 9 and 11 may cross the address electrodes 13.

Accordingly, an address voltage (Va) may be applied between the address electrodes 13 and the display electrodes to generate an address discharge to select discharge cells to operate. Similarly, a sustain voltage (Vs) may be applied between pairs of display electrodes to generate sustain discharge between selected discharge cells. The sustain discharge in selected discharge cells may excite a respective photoluminescent layer therein to emit visible light toward the second substrate 1 to display an image.

The PDP may have improved discharge efficiency and brightness maintenance ratio due to reduced amount of impurities in the barrier ribs thereof. Further, the PDP may be formed at lower temperatures, i.e., a lower firing temperature, thereby exhibiting reduced damage generated by high temperatures.

### EXAMPLES

### Example 1

An amount of 70 g of glass powder containing ZnO—B₂O₃—SiO₂—Al₂O₃ was mixed with 5 g of ethyl cellulose (EC) binder and 20 g of butyl carbitol acetate (BCA) solvent to form a ceramic paste. An amount of 5 g of SeO₂ was added to the ceramic paste to form 100 g of a barrier rib composition.

The 1 g of the barrier rib composition was set as 100% weight at room temperature, and the barrier rib composition was heated at a rate of 10° C./min until the barrier rib composition reached a temperature of 600° C. The weight of the barrier rib composition was measured and recorded at regular intervals relatively to the initial 100% weight to perform a thermogravimetric analysis (TGA).

### Comparative Example 1

An amount of 70 g of glass powder containing ZnO—B₂O₃—SiO₂—Al₂O₃ was mixed with 5 g of ethyl cellulose (EC) binder and 20 g of butyl carbitol acetate (BCA) solvent to form a ceramic paste. An oxide additive was not added to the ceramic paste. TGA was performed on the ceramic paste. An initial weight of 1 g was set as 100% weight for the ceramic paste. The remaining TGA procedure was similar to the procedure performed with respect to the barrier rib composition in Example 1.

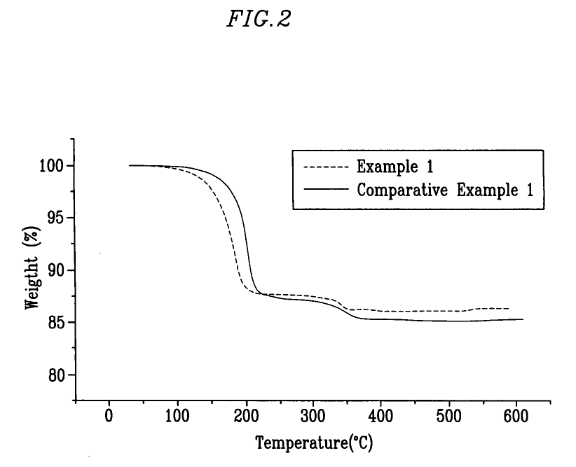

The TGA results of Example 1 and comparative Example 1 are reported in FIG. 2. As illustrated in FIG. 2, the barrier rib composition of Example 1 exhibits higher thermo-decomposition characteristics as compared to the ceramic paste of Comparative Example 1. The oxide additive added to the ceramic paste in Example 1 facilitates efficient removal of residual carbon from the binder employed in the barrier rib composition.

### Examples 2-13

Twelve (12) barrier rib compositions containing ZnO—B₂O₃—SiO₂—Al₂O₃-based glass powder, EC binder, BCA, and an oxide additive were mixed according to proportions indicated in Table 1 below. Each barrier rib composition of Examples 2-13 was analyzed for an amount of residual carbon remaining therein. Further, each barrier rib composition was processed to form barrier ribs and incorporated into a PDP, so that each PDP was evaluated in terms of brightness maintenance ratio and number of black spots.

### Comparative Examples 2-5

Four (4) barrier rib compositions containing ZnO—B₂O₃—SiO₂—Al₂O₃-based glass powder, EC binder, and BCA were mixed according to the proportions indicated in Table 1 below, and an oxide additive were mixed according to proportions indicated in Table 1 below. The barrier rib compositions of Comparative Examples 2-5 were analyzed for an amount of residual carbon remaining therein. Further, the barrier rib composition was processed to form barrier ribs and incorporated into a PDP, so that the PDP was evaluated in terms of brightness maintenance ratio and number of black spots.

TABLE 1

| | Glass | EC | Oxide Additive | | | |
|---|---|---|---|---|---|---|
| | powder | Binder | | Weight | Weight | BCA |
| | (kg) | (kg) | Kind | ratio | (kg) | (kg) |
| Comp. Ex. 2 | 19 | 1.0 | — | — | — | 4.5 |
| Comp. Ex. 3 | 19 | 1.0 | V₂O₅ | — | 0.25 | 4.26 |
| Comp. Ex. 4 | 18.4 | 1.0 | MoO₃ | — | 0.49 | 4.61 |
| Comp. Ex. 5 | 18.4 | 1.0 | CeO₂ | — | 0.74 | 4.37 |
| Ex. 2 | 19 | 1.0 | SeO₂ | — | 0.25 | 4.26 |
| Ex. 3 | 17.9 | 1.0 | SeO₂, V₂O₅ | 1:1 | 0.98 | 4.62 |
| Ex. 4 | 17.9 | 1.0 | MoO₃, CeO₂ | 1:1 | 0.98 | 4.62 |
| Ex. 5 | 17.4 | 1.0 | SeO₂, CeO₂ | 1:1 | 1.23 | 4.88 |
| Ex. 6 | 17.4 | 1.0 | V₂O₅, MoO₃ | 1:1 | 1.23 | 4.88 |
| Ex. 7 | 16.8 | 1.0 | SeO₂, MoO₃ | 1:1 | 1.72 | 4.99 |
| Ex. 8 | 16.8 | 1.0 | V₂O₅, CeO₂ | 1:1 | 1.72 | 4.99 |
| Ex. 9 | 16.2 | 1.0 | SeO₂, V₂O₅, | 1:1:1 | 1.96 | 5.34 |
| | | | MoO₃ | | | |
| Ex. 10 | 16.2 | 1.0 | SeO₂, V₂O₅, | 1:1:1 | 1.96 | 5.34 |
| | | | CeO₂ | | | |
| Ex. 11 | 16.2 | 1.0 | SeO₂, | 1:1:1 | 1.96 | 5.34 |
| | | | MoO₃, CeO₂ | | | |
| Ex. 12 | 15.6 | 1.0 | V₂O₅, | 1:1:1 | 2.45 | 5.45 |
| | | | MoO₃, CeO₂ | | | |
| Ex. 13 | 15.6 | 1.0 | SeO₂, V₂O₅, | 1:1:1:1 | 2.45 | 5.45 |
| | | | MoO₃, CeO₂ | | | |

Manufacturing of a PDP: each barrier rib composition of Examples 2-13 and Comparative Examples 2-5 was coated on a dielectric layer of a first substrate of a PDP to a thickness of 300 μm and fired at 560° C. for 15 minutes to form a barrier rib material. A photosensitive film (BF704, Tokyo Ohka Kogyo Co., Ltd.) was laminated on the barrier rib material, exposed, and developed to pattern the first substrate. The patterned first substrate was put in an etching device mounted with a sprayer, and sprayed with an etching solution of hydrochloric acid and sulfuric acid at a weight ratio of 8:2 to etch the barrier rib material to form the barrier ribs. The spraying pressure was 3 kgf, the diameter of the spray nozzle was 0.5 mm, the spraying height was 120 mm, and the spraying temperature was 30° C. Once the barrier ribs were formed, the photosensitive film was removed.

Next, phosphor layers were formed. Six (6) parts by weight of EC were mixed with hundred (100) parts by weight of a mixture of BCA/terpineol at a weight ratio of 4:6. Forty (40) parts by weight of BaMgAl₁₀O₁₇:Eu blue phosphor were mixed with hundred (100) parts by weight of the BCA/terpineol mixture to form a phosphor paste. The blue phosphor paste was coated on a bottom surface of the discharge cells and side surfaces of the barrier ribs of the PDP to form a blue phosphor layer. Red and green phosphor layers were formed of (Y,Gd)BO3:Eu and ZnSiO₄:Mn, respectively, according to the same procedure described previously with respect to the blue phosphor layer. The first substrate formed with the barrier ribs and the phosphor layer was dried at 200° C. and fired at 500° C.

A second substrate was manufactured with a display electrode, a dielectric layer, and a protective layer. The first substrate was assembled with the second substrate, sealed, degassed, injected with the discharge gas, and set for aging to provide a PDP.

TABLE 2

| | | | | | | Brightness | Number |
|---|---|---|---|---|---|---|---|
| | Residual carbon content (ppm) | | | | Initial | Ratio after | of black |
| | C | CO | (CH)²⁹ | (CH)⁴⁵ | brightness | 500 hr | spot |
| Comp. Ex. 2 | 1.28 × 10⁻³ | 2.21 × 10⁻³ | 8.63 × 10⁻⁴ | 6.24 × 10⁻⁵ | 100.0% | 81.1% | 0 |
| Comp. Ex. 3 | 8.96 × 10⁻⁵ | 3.52 × 10⁻⁶ | 4.75 × 10⁻⁶ | 5.16 × 10⁻⁷ | 105.6% | 85.1% | 0 |
| Comp. Ex. 4 | 7.60 × 10⁻⁵ | 6.22 × 10⁻⁶ | 5.96 × 10⁻⁶ | 8.55 × 10⁻⁷ | 106.2% | 84.8% | 0 |
| Comp. Ex. 5 | 5.34 × 10⁻⁵ | 3.36 × 10⁻⁶ | 6.14 × 10⁻⁶ | 4.46 × 10⁻⁷ | 107.1% | 85.7% | 0 |
| Ex. 2 | 5.20 × 10⁻⁵ | 1.83 × 10⁻⁶ | 3.75 × 10⁻⁶ | 6.81 × 10⁻⁷ | 104.3% | 84.2% | 0 |
| Ex. 3 | 6.27 × 10⁻⁵ | 6.68 × 10⁻⁶ | 2.38 × 10⁻⁶ | 3.41 × 10⁻⁷ | 106.4% | 85.9% | 0 |
| Ex. 4 | 7.99 × 10⁻⁵ | 2.91 × 10⁻⁶ | 6.43 × 10⁻⁶ | 5.73 × 10⁻⁷ | 107.7% | 87.8% | 0 |
| Ex. 5 | 7.81 × 10⁻⁵ | 4.55 × 10⁻⁶ | 5.69 × 10⁻⁶ | 5.24 × 10⁻⁷ | 108.2% | 88.8% | 0 |
| Ex. 6 | 8.18 × 10⁻⁵ | 7.29 × 10⁻⁶ | 2.52 × 10⁻⁶ | 3.32 × 10⁻⁷ | 110.2% | 88.7% | 0 |
| Ex. 7 | 4.18 × 10⁻⁵ | 6.94 × 10⁻⁶ | 3.21 × 10⁻⁶ | 4.56 × 10⁻⁷ | 106.2% | 86.3% | 0 |
| Ex. 8 | 2.00 × 10⁻⁵ | 9.56 × 10⁻⁶ | 1.88 × 10⁻⁶ | 2.34 × 10⁻⁷ | 107.1% | 86.8% | 0 |
| Ex. 9 | 4.71 × 10⁻⁵ | 4.69 × 10⁻⁶ | 5.17 × 10⁻⁶ | 9.12 × 10⁻⁷ | 107.7% | 87.1% | 0 |
| Ex. 10 | 7.89 × 10⁻⁵ | 5.28 × 10⁻⁶ | 4.34 × 10⁻⁶ | 8.98 × 10⁻⁷ | 107.4% | 88.1% | 0 |
| Ex. 11 | 6.97 × 10⁻⁵ | 3.37 × 10⁻⁶ | 1.26 × 10⁻⁶ | 7.42 × 10⁻⁷ | 107.9% | 87.4% | 0 |
| Ex. 12 | 5.24 × 10⁻⁵ | 5.84 × 10⁻⁶ | 3.48 × 10⁻⁶ | 5.46 × 10⁻⁷ | 105.3% | 87.6% | 0 |
| Ex. 13 | 6.18 × 10⁻⁵ | 6.63 × 10⁻⁶ | 5.98 × 10⁻⁶ | 6.64 × 10⁻⁷ | 105.7% | 85.9% | 0 |

The residual amount of carbon was determined by thermal desorption spectroscopy (TDS). The barrier rib compositions of Examples 2-13 and Comparative Examples 2-5 were heated under ultrahigh vacuum conditions and evaluated with a mass spectrometer. Masses of C, CO, (CH)²⁹, and (CH)⁴⁵ were determined for each sample. TDS results for each carbon species are reported in Table 2 above.

The brightness maintenance ratio was determined with respect to a full white state of the PDP. The initial brightness was set for each PDP as a relative brightness with respect to brightness of PDP employing the composition of Comparative Example 2. Next, a contact brightness meter (CA-100 plus by Minolta) was used to evaluate brightness of each sample after every 100 hours. Brightness of each sample after 500 hours was compared to a respective initial brightness to determine brightness maintenance ratio.

The number of black spots was determined by counting the number of broken barrier ribs due to vibration of the PDP. The PDP was vibrated at 1.50 Grm in the vertical direction for 2 hours, while an external impact from a height of 1 m was applied thereto three times. The number of black spots was evaluated in order to determine whether use of an oxide additive weakens the barrier ribs and reduces support of the first/second PDP substrates.

As shown in Table 2 above, the residual carbon content in Examples 2-13 was significantly lower as compared to the residual carbon content in Comparative Examples 2-5. Further, the initial brightness of a PDP having a barrier rib composition with an oxide additive exhibits an increase of about 5% to about 10% with respect to the initial brightness of Comparative Examples 2-13, i.e., a PDP having a barrier rib composition without an oxide additive. Similarly, a brightness maintenance ratio of a PDP having a barrier rib composition with an oxide additive is about 3% to about 7% higher with respect to the initial brightness of Comparative Examples 2-13, i.e., a PDP having a barrier rib composition without an oxide additive. Finally, the number of black spots was not increased due to use of an oxide additive.

The barrier rib composition for a PDP according to embodiments of the present invention provide barrier ribs with enhanced thermal conductivity and improved residual carbon decomposition rate at lower firing temperatures. Accordingly, a PDP with barrier ribs formed of a barrier rib composition according to embodiment of the present invention may have reduced damage due to a high firing temperature and reduced amount of impurities, thereby providing high luminous efficiency and brightness maintenance ratio.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A barrier rib composition, comprising a ceramic material, a binder, a solvent, and a selenium oxide additive.

2. The composition as claimed in claim 1, wherein the additive is present in an amount of about 1% to about 10% by total weight of the composition.

3. The composition as claimed in claim 1, wherein the composition further comprises an oxide including at least one of vanadium oxide, molybdenum oxide, and cerium oxide.

4. The composition as claimed in claim 1, wherein the ceramic material includes glass powder.

5. The composition as claimed in claim 4, wherein the glass powder includes one or more of a lead oxide, a silicon oxide, an aluminum oxide, a magnesium oxide, and a titanium oxide.

6. The composition as claimed in claim 1, wherein the binder includes one or more of an acryl-based compound, an epoxy-based compound, and a cellulose-based compound.

7. The composition as claimed in claim 6, wherein the binder is a cellulose-based compound, the cellulose-based compound including at least one of ethyl-cellulose-based compound and nitro-cellulose-based compound.

8. The composition as claimed in claim 1, wherein the solvent includes one or more of ethanol, trimethylpentanediol monoisobutylate, butyl carbitol, butyl cellosolve, butyl carbitol acetate, terpineol, toluene, and texanol.

9. A barrier rib composition comprising, a ceramic material, a binder, a solvent, and an additive including at least two of a selenium oxide, a vanadium oxide, a molybdenum oxide, and a cerium oxide.

10. The composition as claimed in claim 9, wherein the additive is present in an amount of about 1% to about 10% by total weight of the composition.

11. The composition as claimed in claim 9, wherein the additive includes at least three of a selenium oxide, a vanadium oxide, a molybdenum oxide, and a cerium oxide.

12. The composition as claimed in claim 9, wherein the ceramic material includes glass powder.

13. The composition as claimed in claim 12, wherein the glass powder includes one or more of a lead oxide, a silicon oxide, an aluminum oxide, a magnesium oxide, and a titanium oxide.

14. The composition as claimed in claim 9, wherein the binder includes one or more of an acryl-based compound, an epoxy-based compound, and a cellulose-based compound.

15. The composition as claimed in claim 14, wherein the binder is a cellulose-based compound, the cellulose-based compound including at least one of ethyl-cellulose-based compound and nitro-cellulose-based compound.

16. The composition as claimed in claim 9, wherein the solvent includes one or more of ethanol, trimethylpentanediol monoisobutylate, butyl carbitol, butyl cellosolve, butyl carbitol acetate, terpineol, toluene, and texanol.

17. A plasma display panel (PDP), comprising:
a first substrate facing a second substrate;
a plurality of address and display electrodes between the first and second substrates;
a plurality of barrier ribs between the first substrate and the second substrate to define a plurality of discharge cells, the plurality of barrier ribs including a selenium oxide additive; and
photoluminescent material in the discharge cells.

18. The PDP as claimed in claim 17, wherein the additive is present in an amount of about 1% to about 10% by total weight of the barrier rib.

19. The PDP as claimed in claim 17, wherein the barrier ribs further comprises an oxide including at least one of a vanadium oxide, a molybdenum oxide, or a cerium oxide.

20. A plasma display panel (PDP), comprising:
a first substrate facing a second substrate;
a plurality of address and display electrodes between the first and second substrates;
a plurality of barrier ribs between the first substrate and the second substrate to define a plurality of discharge cells, the plurality of barrier ribs including at least two additives of a selenium oxide, a vanadium oxide, a molybdenum oxide, and a cerium oxide; and
photoluminescent material in the discharge cells.

21. The PDP as claimed in claim 20, wherein the additive is present in an amount of about 1% to about 10% by total weight of the barrier rib.

22. The PDP as claimed in claim 20, wherein the additive includes at least three additives of a selenium oxide, a vanadium oxide, a molybdenum oxide, and a cerium oxide.
